(19) United States
(12) Patent Application Publication
(10) Pub. No.: US 2019/0327978 A1
(43) Pub. Date: Oct. 31, 2019

(54) Natural Insect Repellent

(71) Applicant: Triple J Farm NY, LLC, Stanfordville, NY (US)

(72) Inventor: Jin Kidd, Stanfordville, NY (US)

(21) Appl. No.: 15/965,790

(22) Filed: Apr. 27, 2018

(51) Int. Cl. A01N 65/34; A01N 65/06; A01N 65/22; A01N 65/28; A01N 65/44; A01N 65/08; A01N 25/02

(52) U.S. Cl. CPC A01N 65/34; A01N 65/06; A01N 65/22; A01N 25/02; A01N 65/44; A01N 65/08; A01N 65/28

(57) ABSTRACT

An all-natural, organic, and effective insect repellent spray comprising apple cider vinegar and cedar wood oil, distilled water, peppermint oil, eucalyptus oil, citronella oil, lemongrass oil, and geranium oil.

### (1) TECHNICAL FIELD

The disclosure relates to insect repellents, and more particularly, to an all-natural effective insect repellent.

### (2) BACKGROUND

The so-called “Deer tick,” Ixodus scapularis, and numerous other ticks bite humans and spread Lyme disease, Rocky Mountain Spotted Fever, and many other diseases. There are no effective vaccines against these diseases for humans.

The current recommendations of the Centers for Disease Control (CDC) for avoiding tick bites are limited to the use of DEET (N,N-Diethyl-meta-toluamide), picordin, or IR3535 on exposed skin every few hours. Some people are hesitant to use these chemicals on their skin. There is a wide range of more natural products for tick repelling, but their effectiveness is questionable at best.

Several U.S. Patents including U.S. Pat. No. 8,647,684 (Baube) and U.S. Pat. No. 7,947,311 (Porter et al) teach natural insect repellent formulations including essential oils. Various websites disclose recipes for all natural insect repellents.

### SUMMARY

A principal object of the present disclosure is to provide an all-natural and effective insect repellent.

In accordance with the objects of the disclosure an all-natural, organic, and effective insect repellent spray is achieved. The spray comprises apple cider vinegar and cedar wood oil, distilled water, peppermint oil, eucalyptus oil, citronella oil, lemongrass oil, and geranium oil.

### DETAILED DESCRIPTION

The present disclosure describes an insect repellent formulation that is all-natural and effective in repelling insects from humans. Cedar wood oil is an Environmental Protection Agency (EPA) registered tick killer. The formulation of the present disclosure combines cedar wood oil with highly acidic fermented apple cider vinegar. In field tests, this formulation hides the scent of humans and repels both ticks and mosquitoes.

The natural insect repellent of the present disclosure is safe and effective for the whole family. All ingredients are certified organic by the United States Department of Agriculture (USDA) and Oregon Tilth. The repellent of the present disclosure is a safe way to repel ticks and insects without synthetic harsh chemicals. It is formulated with certified organic essential oils to safely repel insects. The repellent is hypoallergenic, non-irritating, and vegan. It contains no fragrances, dyes, DEET, phthalates, parabens, pesticides, alcohol, formaldehyde, preservatives, or petrochemicals.

More specifically, the formulation of the present disclosure is a composition of matter comprising fermented apple cider vinegar, cedar wood oil (cedrus atlantica), peppermint oil (mentha piperita), eucalyptus oil (eucalyptus globulus), citronella oil (cymbopogon nardus), lemongrass oil (cymbopogon flexuosus), and geranium oil (pelargonium graveolens).

Each of the primary constituent ingredients has beneficial properties. For example, cedar wood oil is an EPA registered tick killer. Apple cider vinegar, being acetic acid, kills insects on contact. The other oils act as deterrents for a variety of biting insects and mosquitoes

While there are other natural combinations in the marketplace, they appear to be random and less than highly effective. The composition of the present disclosure has been researched and tested and found to be highly effective.

To prepare the insect repellent of the present disclosure, approximately 40-60% by volume fermented apple cider vinegar and approximately 40 to 60% by volume distilled water are mixed. The specific combination of essential oils is then added to the base mixture. The combination of essential oils together will be about 10 to 20% by volume of the composition.

The insect repellent of the present disclosure is a liquid poured into a spray bottle. In use, the bottle is to be shaken and then the insect repellent is sprayed liberally and evenly to exposed skin and clothing every two to three hours.

Although the preferred embodiment of the present disclosure has been illustrated, and that form has been described in detail, it will be readily understood by those skilled in the art that various modifications may be made therein without departing from the spirit of the disclosure or from the scope of the appended claims.

What is claimed is:

1. An insect repellent spray comprising: apple cider vinegar, distilled water, cedar wood oil, peppermint oil, eucalyptus oil, citronella oil, lemongrass oil, and geranium oil.

2. The insect repellent spray of claim 1 wherein said apple cider vinegar is about 40-60% by volume, said distilled water is about 40-60% by volume, and said cedar wood oil, peppermint oil, eucalyptus oil, citronella oil, lemongrass oil, and geranium oil together is about 10-20% by volume of said insect repellent spray.
